(19) United States
(12) Patent Application Publication
(10) Pub. No.: US 2004/0095888 A1
(43) Pub. Date: May 20, 2004

(54) Apparatus and methods for network connected information handling systems devices

(75) Inventor: Francis E. Noel JR., Durham, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/295,232

(22) Filed: Nov. 15, 2002

(51) Int. Cl. H04J 1/16; H04Q 7/00

(52) U.S. Cl. 370/238; 370/328

(57) ABSTRACT

Wirelessly connected information handling system devices such as access points and end user devices are Layer 3 aware, particularly in respect to knowing the IP address of the stations wirelessly connected to them. With capability for full Layer 3 functionality, the use of Open Shortest Path First (OSPF) in these products provides a well tested, very robust method moving from a large flat LAN environment to the hierarchical world of IP routing.

### FIELD AND BACKGROUND OF THE INVENTION

The description which follows presupposes knowledge of network data communications and switches and routers as used in such communications networks. In particular, the description presupposes familiarity with the ISO model of network architecture which divides network operation into layers. A typical architecture based upon the ISO model extends from Layer 1 (also sometimes identified as “L1”) being the physical pathway or media through which signals are passed upwards through Layers 2, 3, 4 and so forth to Layer 7, the last mentioned being the layer of applications programming running on a computer system linked to the network. In this document, mention of L1, L2 and so forth is intended to refer to the corresponding layer of a network architecture. The disclosure also presupposes a fundamental understanding of bit strings known as packets and frames in such network communication.

The 802.11 standard is a family of specifications created by the Institute of Electrical and Electronics Engineers Inc. for wireless local area networks in the 2.4-gigahertz bandwidth space. 802.11 can be thought of as a way to connect computers and other electronic devices to each other and to the Internet at very high speed without any cumbersome wiring—basically, a faster version of how a cordless phone links to its base station. With 802.11, electronic devices can talk to each other over distances of about 300 feet at 11 megabits a second, which is faster than some wired networks in corporate offices.

Devices using 802.11—increasingly known as Wi-Fi—are relatively inexpensive. A network access point intended for installation at a stationary location can be bought for about $500 and will coordinate the communication of all 802.11 equipped devices within range and provide a link to the Internet and/or any intranet to which the access point is linked. The cards that let a laptop computer or other device “plug” into the network cost $100 to $200. Some personal communication devices come enabled for 802.11 communications without the need of an additional card. Wireless 802.11 cards and access points are flying off the shelves of computer suppliers. People want and find easy connectivity with 802.11-standard products.

With the rapidly decreasing costs for wireless Local Area Networks (LANs), and with the tremendous ease of installation of such networks, they are rapidly proliferating in homes (for personal use and for home offices), for small business as well as for large enterprises. Because of the relative newness of the technology to provide complete LAN's, the significant issue of routing through the wireless LAN and interconnecting devices such as laptop computer systems and other mobile clients such as personal digital assistants (PDAs) and telephones has not been adequately addressed.

IEEE 802.11 has specified a standard for wireless networks that has met the goals of the standards committee: 1) Easy to install and use, 2) based on technology that is intrinsically based on low cost components (and has every expectation to be come even less expensive with time) and, 3) like it's parent standard, IEEE 802.3, promises to become ubiquitous because of it's high speed (11 Mbps) and its “Networking for Dummies” simplistic approach to networking and installation. All of these well regarded features come with a significant drawback: when used in larger networks, they operate as one large “flat” LAN, which with very little growth can soon have significant performance problems.

Successor technologies to 802.11 are on the horizon. One is ultra-wide band radio technology or UWB, which uses a wide spectrum technology at low power to transfer data at a very high speed. UWB will be perhaps ten times faster than 802.11, yet suffer from some of the same difficulties addressed here. Another is the inclusion of radio frequency function directly on chips which perform other functions such as system central processors and network processors.

It is important to note that wireless access nodes or points today function at Layer 2 and do not have knowledge of Layer 3 addressing, while the core router to which they are connected has full knowledge of Layer 3 addressing. As semiconductor technology has advanced, more and more function is being has been incorporated in to the wireless access points. For example, originally these were simplistic “wiring concentrators” such as the original wired IBM 8228 which was a completely unpowered product. Today these access points are sophisticated Layer 2 switches with full knowledge of the Layer 2, or Medium Access Control (MAC), addresses of the wireless devices that are connected to them.

### BRIEF DESCRIPTION OF INVENTION

The present invention contemplates that such access points and other devices be fully Layer 3 aware, particularly in respect to knowing the IP address of the stations wirelessly connected to them. Once these wireless devices become capable of full Layer 3 functionality, the use of Open Shortest Path First (OSPF) in these products will provide a well tested, very robust method moving from the large flat LAN environment to the hierarchical world of IP routing. Thus a purpose of this invention is to improve network capabilities of wireless devices by facilitating implementation of favorable routing protocols at such a point, network node, or end device.

In realizing this purpose, intercommunication between and among wireless enabled devices is adapted to practices known to architects, designers and implementors of wireline networks, facilitating proliferation of communications channels.

### BRIEF DESCRIPTION OF DRAWINGS

Some of the purposes of the invention having been stated, others will appear as the description proceeds, when taken in connection with the accompanying drawings, in which:

FIG. 1 is a schematic representation of a network installed within a facility, including workstation computer systems and a server computer system;

FIG. 2 is a schematic representation of a wireless access point such as may be functional in the network shown in FIG. 1 and which has awareness of Layer 3 flows; and

FIG. 3 is a simplified flow chart showing steps performed in the network of FIG. 1.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

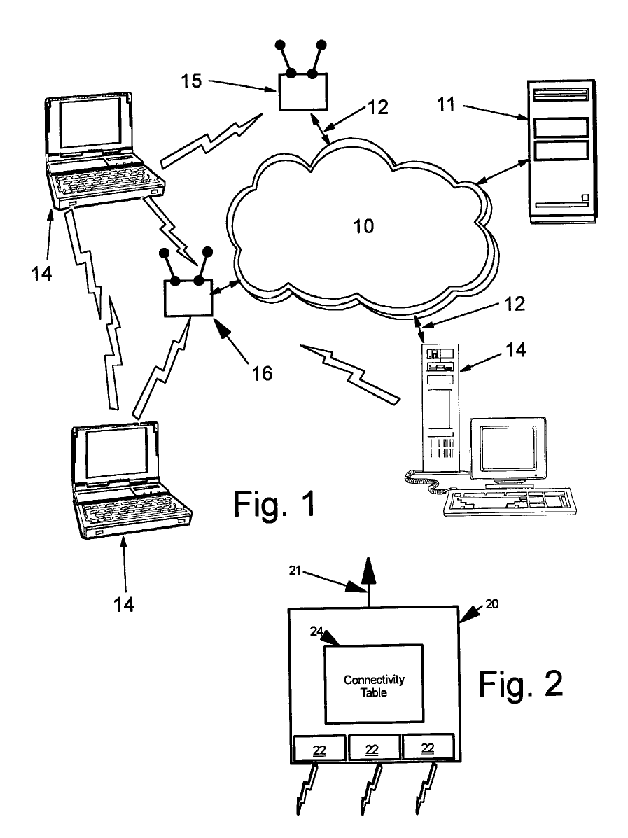

Referring now more particularly to the Figures, FIG. 1 illustrates a network 10 having a server computer system 11, a plurality of stationary access points 12 which may be either wireless or wired, and a plurality of workstation computer systems 14. Each workstation computer system 14 is coupled to the network, either through a wireless connection or possibly through a wired connection or both. Depending upon the size and scope of a facility, managed networks may have a mix of types of systems and types of connections. The workstations may be notebook computer systems, personal digital assistant systems, advanced function telephones, desktop or minitower systems, or other devices capable of accessing the network 10 through the access points. All of the illustrated devices may be known as information handling system devices. Some have capabilities for wireless communication of data, and are the particular focus of the discussion here.

The present invention contemplates that the stationary access points 12 and the workstations 14 have awareness of Layer 3 communications. With regard to the access points 12, where such points are what has become known as “edge routers” (typically wire line connected and “at the end of the network line”), such capability is sometimes provided in such apparatus. Prior to the present invention, such capability has been highly unusual if present at all in end point devices such as workstations 14, reliance instead being placed on the connection of such devices to edge routers. Layer 3 awareness can be provided, as shown for example in FIG. 2 where a wireless access point 20 which has a wireline connection 21 and at least one wireless connection port 22 includes circuitry such as a network processor retaining a routing or connectivity table 24, by the inclusion of appropriate elements now or becoming available. The same or similar implementation can be done with an “end point” device such as a user system 14.

Industry consultants have defined a network processor (herein also mentioned as an “NP”) as a programmable communications integrated circuit capable of performing one or more of the following functions:

Packet classification—identifying a packet based on known characteristics, such as address or protocol;

Packet modification—modifying the packet to comply with IP, ATM, or other protocols (for example, updating the time-to-live field in the header for IP);

Queue/policy management—reflecting the design strategy for packet queuing, de-queuing, and scheduling of packets for specific applications; and

Packet forwarding—transmission and receipt of data over a switch fabric and forwarding or routing the packet to the appropriate address.

Although this definition is an accurate description of the basic features of early NPs, the full potential capabilities and benefits of NPs are yet to be realized. Network processors can increase bandwidth and solve latency problems in a broad range of applications by allowing networking tasks previously handled in software to be executed in hardware. In addition, NPs can provide speed improvements through architectures, such as parallel distributed processing and pipeline processing designs. These capabilities can enable efficient search engines, increase throughput, and provide rapid execution of complex tasks.

Network processors are expected to become the fundamental network building block for networks in the same fashion that CPUs are for PCs. Typical capabilities offered by an NP are real-time processing, security, store and forward, switch fabric connectivity, and IP packet handling and learning capabilities. NPs target ISO layer two through five and are designed to optimize network-specific tasks.

The processor-model NP incorporates multiple general purpose processors and specialized logic. Suppliers are turning to this design to provide scalable, flexible solutions that can accommodate change in a timely and cost-effective fashion. A processor-model NP allows distributed processing at lower levels of integration, providing higher throughput, flexibility and control. Programmability can enable easy migration to new protocols and technologies, without requiring new ASIC designs. With processor-model NPs, network equipment vendors benefit from reduced non-refundable engineering costs and improved time-to-market.

In accordance with conventional network operation, nodes in the network 10 maintain connectivity tables containing addresses of others nodes with which communication can be established. Depending upon the characteristics of the node in which such a table is maintained, the table may be known as a routing or trusted neighbor table. Such tables are periodically refreshed based on broadcast advertisements of detected connectivity. The present invention takes advantage of such routing or trusted neighbor tables and the ability of an intelligent node to perform processing as described above.

With Layer 3 awareness and capability in the devices joined together in the network 10 of FIG. 1, the devices can implement the routing protocol known as Open Shortest Path First or OSPF. OSPF is set forth in Internet Engineering Task Force (IETF) RFC-1583, to which the interested reader is referred. With implementation of OSPF, a known network routing protocol enables, for example, a workstation which is remote from a wireless access point or an access point which is remote from a server computer system to transmit and receive data packets which flow through intermediate devices. Thus, if the packet is compared to a frog in a pond filled with information handling system device lilypads, the frog can jump from lilypad to lilypad and go from one side of the pond to the other. As contemplated by this invention, data flows following the known OSPF protocol enable the quick and easy formation of ad hoc networks of devices which are in sufficient proximity to enable radio linking.

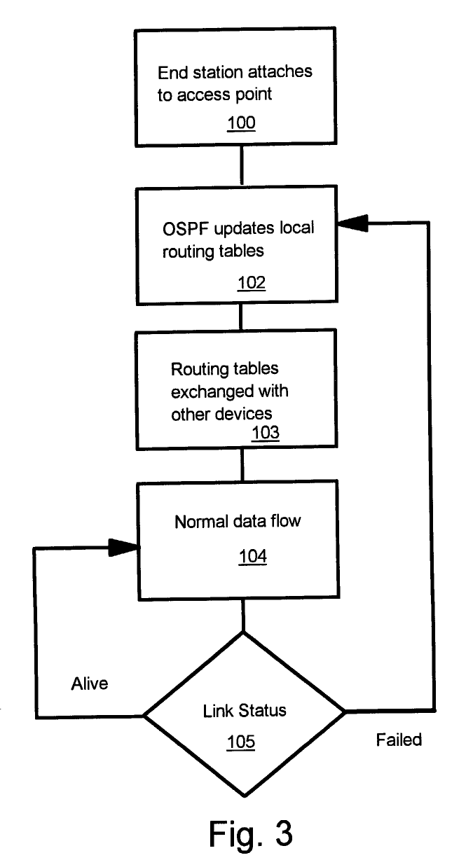

Such data flows are schematically represented by the flow chart of FIG. 3. As there shown, an end station opens communication with another L3 aware device as a beginning step 100. OSPF then updates the local routing table with a new entry at 101 and exchanges the routing table updates with other devices at 102. Normal data flow then progresses at 103. The link status is monitored at 104 and, as the link remains alive, normal data flow continues. Should the link status indicate a failure, then the program returns to the step at which OSPF updates routing tables at 101.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
an information handling system device capable of wireless linking to another information handling system device;
circuitry within said device capable of Layer 3 addressing; and
program instructions stored accessibly to said circuitry and effective when executing therein to practice OSPF.

2. Apparatus according to claim 1 wherein said information handling system device is a wireless access point.

3. Apparatus according to claim 1 wherein said information handling system device is an end user device.

4. A method comprising the steps of:
providing an information handling system device capable of wireless linking to another information handling system device with the capability to handle Layer 3 addressing: and
executing at the device program instructions stored accessibly thereto which effectuate OSPF.

5. A method according to claim 4 wherein the step of providing a device consists of providing a wireless access point.

6. A method according to claim 4 wherein the step of p[roviding a device consists of providing an end user device.
